(19) United States
(12) Patent Application Publication
(10) Pub. No.: US 2025/0293465 A1
(43) Pub. Date: Sep. 18, 2025

(54) CABLE CONNECTOR

(71) Applicant: QIDONG LINKCONN ELECTRONICS CO., LTD., Nantong (CN)

(72) Inventors: Songtao CHEN, Nantong (CN); Yanfei DAI, Nantong (CN)

(21) Appl. No.: 19/226,190

(22) Filed: Jun. 3, 2025

Related U.S. Application Data
(63) Continuation of application No. PCT/CN2023/129193, filed on Nov. 2, 2023.

(30) Foreign Application Priority Data
Dec. 7, 2022 (CN) 202223268939.5
Apr. 13, 2023 (CN) 202310394230.X

(51) Int. Cl. H01R 13/658; H01R 13/405

(52) U.S. Cl. CPC H01R 13/658; H01R 13/405

(57) ABSTRACT

A cable connector, includes an insulative seat, at least one external terminal, at least one insulator inserted and fixed inside the external terminal, at least one central terminal inserted and fixed in the insulator and at least one cable. The external terminal includes an outer contacting portion located at the front end and an outer connecting portion located at the rear end, the central terminal includes a central connecting portion located at the rear end, the cable includes a conductor, an insulating layer wrapping around the conductor and a metal braided layer, the central connecting portion is connected to the conductor, and the outer connecting portion is connected to the braided layer, wherein the external terminal is provided with a seamless hollow cylindrical structure, and the insulator is placed inside the hollow cylindrical structure, and the hollow cylindrical structure is supported on the insulating seat.

### CROSS-REFERENCE TO RELATED APPLICATIONS

This present disclosure is a continuation application of International Application No. PCT/CN2023/129193, filed on Nov. 2, 2023, which claims priority to Chinese Patent Application No. 202223268939.5, filed on Dec. 7, 2022, with the Chinese Patent Office, and Chinese Patent Application No. 202310394230.X, filed on Apr. 13, 2023, with the Chinese Patent Office, the disclosures of which are incorporated herein by reference in their entireties.

### TECHNICAL FIELD

The present disclosure relates to a cable connector, and more particularly to a cable connector with at least one external terminal.

### BACKGROUND

With the rapid development of the automotive industry, the level of autonomous driving in cars is constantly improving, which requires more transmission channels and higher frequencies for the vehicle-mounted RF (Radio Frequency) interconnection system. The traditional automotive “FAKRA” interconnection system based on size and frequency range limitations can no longer meet future requirements, such as 360-degree surround view, fatigue driving, 5G communication, GPS, and vehicle-to-machine communication will enable the RF (Radio Frequency) interconnection system of the vehicle to reach more than 10 channels. However, the traditional automotive “FAKRA” interconnection systems will occupy more space and require higher costs; therefore, it is necessary to develop a small coaxial contact component with higher frequency, smaller volume, easier modular assembly and mass production to adapt to the development of the automotive industry.

Existing cable connectors generally include insulators, central terminals, external terminals and cables, etc., the central terminal is inserted and fixed on the insulator, the external terminal is sleeved on the insulator, the insulator isolates the central terminal and the external terminal, and the external terminal is stamped ring structure. The product has a large external dimensional tolerance, which causes the inability to fit properly with the docking connector during use. In addition, there is a radio frequency leakage defect at the joint line of the stamped ring.

Hence, a new and simple cable connector is desired to improve those disclosed in the aforementioned proposal.

### SUMMARY OF THE INVENTION

Accordingly, the object of the present disclosure is a cable connector, includes an insulative seat, at least one external terminal fixed inside the insulating seat, at least one insulator inserted and fixed inside the external terminal, at least one central terminal inserted and fixed in the insulator for the insulator isolation the central terminal from the external terminal, and at least one cable extending backward from the insulating seat. The external terminal includes an outer contacting portion located at the front end and an outer connecting portion located at the rear end, the central terminal includes a central contacting portion located at the front end and a central connecting portion located at the rear end, the cable includes a conductor, an insulating layer wrapping around the conductor, an insulation sheath, and a metal braided layer between the insulating layer and the insulation sheath, the central connecting portion is connected to the conductor, and the outer connecting portion is connected to the braided layer, wherein the external terminal is provided with a seamless hollow cylindrical structure, and the insulator is placed inside the hollow cylindrical structure, and the hollow cylindrical structure is supported on the insulating seat.

Other objects, advantages and novel features of the disclosure will become more apparent from the following detailed description when taken in conjunction with the accompanying drawings.

### BRIEF DESCRIPTION OF THE DRAWINGS

FIG. 1 is a perspective view of a cable connector in the present embodiment.

FIG. 2A is a front perspective view of the cable connector of FIG. 1.

FIG. 2B is a cross-sectional view of the cable connector taken along line 2A-2A of FIG. 2A.

FIG. 3A is a side perspective view of the cable connector of FIG. 1.

FIG. 3B is a cross-sectional view of the cable connector taken along line 3A-3A of FIG. 3A.

FIG. 4 is an exploded perspective view of the cable connector of FIG. 1.

FIG. 5 is a perspective view of a front terminal of the cable connector of FIG. 4.

FIG. 6 is a perspective view of a rear terminal of the cable connector of FIG. 4.

FIG. 7 is a perspective view of a secondary buckle of the cable connector of FIG. 4.

### DETAILED DESCRIPTION

Reference will now be made in detail to the preferred embodiment of the present disclosure.

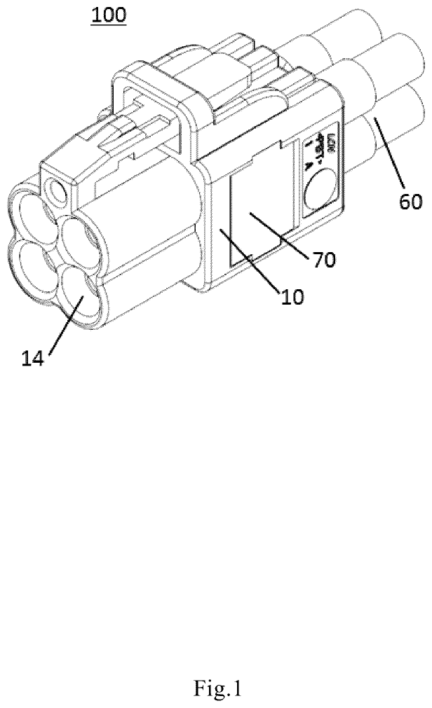

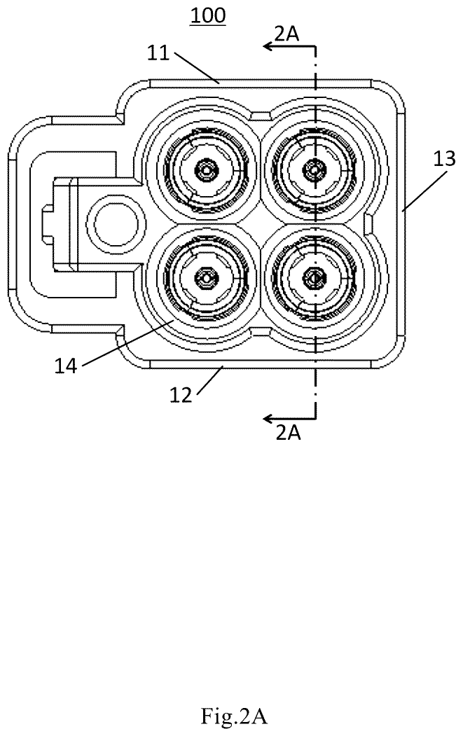

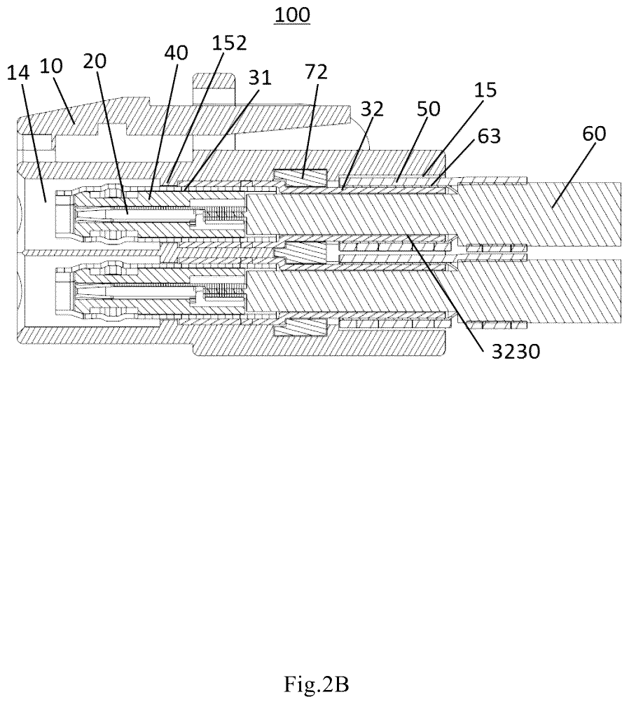

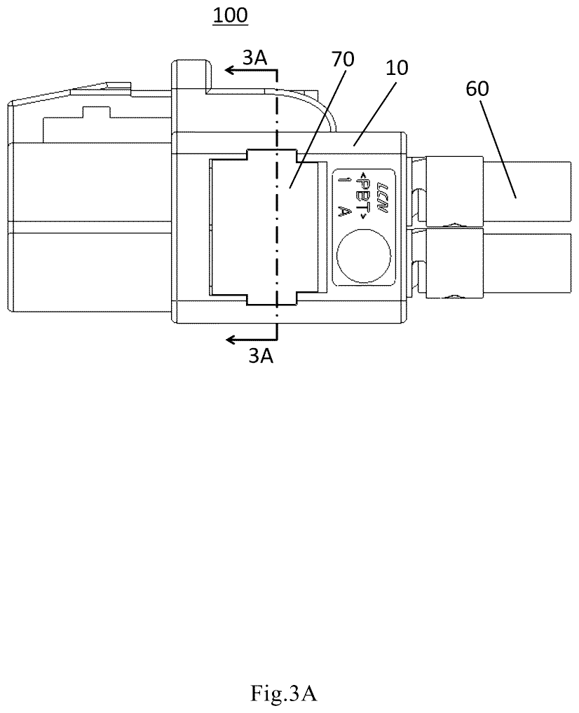

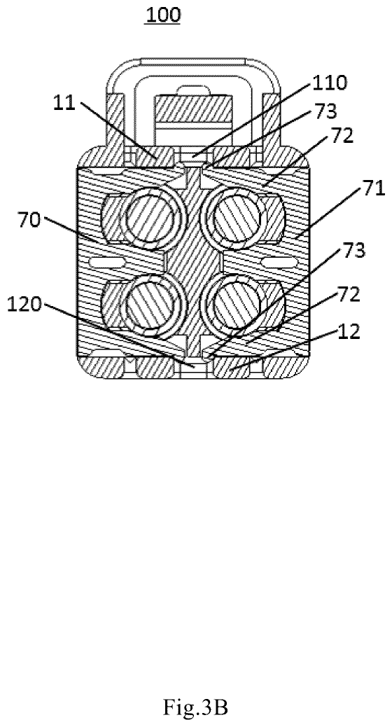

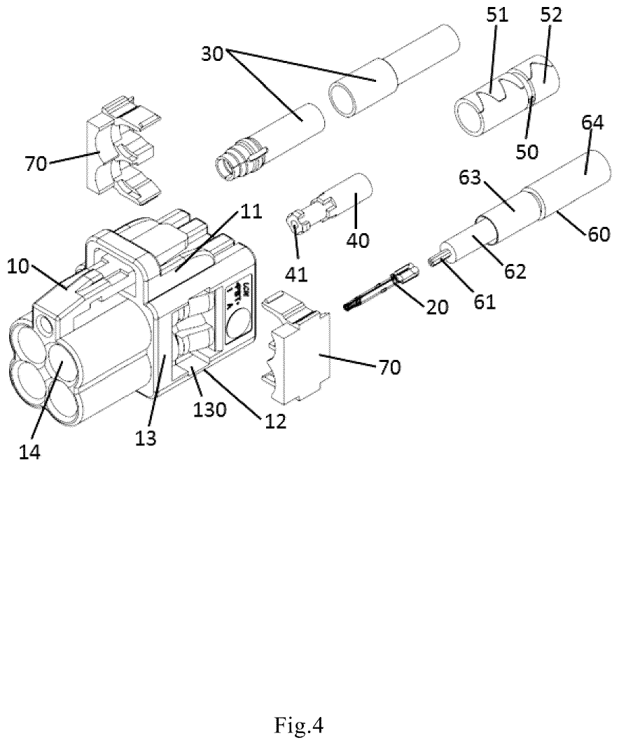

FIG. 1 to FIG. 7 show a cable connector 100, which is used to improve structural strength and high-frequency data transmission quality. The cable connector 10 includes an insulating seat 10, a plurality of terminal components, a plurality of cables 60 and a pair of secondary buckles 70 fixed on the left and right sides of the insulating seat 10. Each terminal component includes a central terminal 20, an external terminal 30, an insulator 40 and a riveting part 50.

The insulating seat 10 includes a top wall 11, a bottom wall 12 corresponding to the top wall 11, a pair of side walls 13 located on the left and right sides, and several insertion holes 14 and several fixing holes 15 formed between the top wall 11, the bottom wall 12 and the two side walls 13. The insertion holes 14 are located at the front end of the insulating seat 10, and each fixing hole 15 extends backwards through the insulation seat 10 from the corresponding insertion hole 14. Each side wall 13 defines a fixed opening 130, which communicates with the fixing holes 15.

The central terminal 20 is designed as a tubular structure, which includes a central contacting portion located at the front end and a central connecting portion located at the rear end. The central contacting portion is designed as a circular shape and defines an insertion port located at the front end for the contacting terminal of the docking connector to be inserted. The central connecting portion is connected to the front end of the cable 60 together.

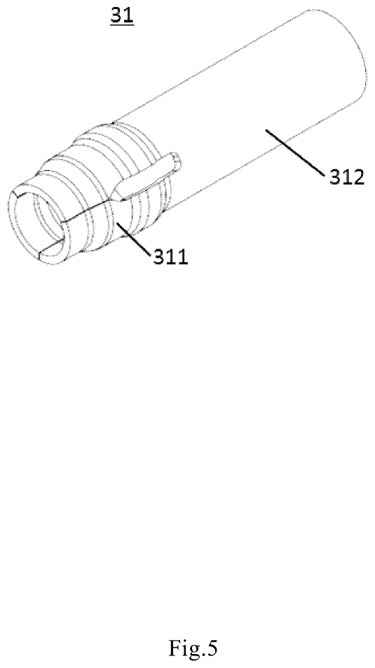

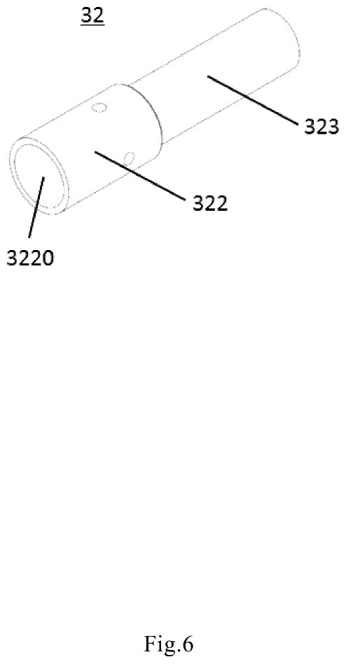

Referring to FIG. 5 to FIG. 6, each external terminal 30 includes a front terminal 31 and a rear terminal 32 that are nested together. In this embodiment, the front terminal 31 and the rear terminal 32 are respectively made by deep drawing process to form a seamless hollow cylindrical structure. Of course, the seamless hollow cylindrical structure can also be formed in other methods, such as expanding pipe hole or lathe processing, as long as a seamless structure is formed. The front terminal 31 includes an outer contacting portion 311 located at the front end and a front sleeve portion 312 extending backward from the outer contacting portion 311. The outer contacting portion 311 is also arranged in a circular shape, surrounding the outside of the insulator 40, and partially protruding forward from the insulator 40, which increases the stability of the support and connection between the insulator 40 and the inside of the hollow cylindrical structure, improves the positional accuracy of the central terminal 20, and ensures reliable contacted with the docking connector.

The rear terminal 32 includes a rear sleeve portion 322 extending forward and backward, and an outer connecting portion 323 extending backward from the rear sleeve portion 322. The rear sleeve portion 322 defines a front through-hole 3220, and the outer connecting portion 323 defines a rear through-hole 3230, the outer diameter of the rear sleeve portion 322 is larger than that of the outer connecting portion 323, and the inner diameter of the front through-hole 3220 is larger than that of the rear through-hole 3230. The front sleeve portion 312 and the rear sleeve portion 322 are plugged together front and back, and the front sleeve portion 312 is inserted and fixed into the front through-hole 3220 of the rear sleeve portion 322, which can be abut against the front end of the external connecting portion 323 to limit the excessive backward movement of the front terminal 31.

The outer side of the hollow cylindrical structure is supported on the insulating seat 10, further increasing the stability of the support between the outer side of the hollow cylindrical structure and the insulating seat 10, improving the positional accuracy of the central terminal 20, and ensuring reliable contact with the docking connector. Furthermore, the front sleeve portion 312 and the rear sleeve portion 322 are fixed together by laser or resistance welding, so as to enhance the connection strength between the front terminal 31 and the rear terminal 32. The fixing hole 15 is equipped with a protrusion 152 located on the inner wall, which abuts against the front sleeve portion 312 backward to prevent the rear terminal 32 from moving forward. The outer connecting portion 323 is suspended in the fixed hole 15. In other embodiments, the rear sleeve portion 322 is inserted forwardly and fixed in the front sleeve portion 312.

In this embodiment, the hollow cylindrical structure of the front terminal 31 and the rear terminal 32 of the above-mentioned external terminal 30 is made of a seamless molding process, which improves the external accuracy and stability of the front terminal and the rear terminal, and increases the structural strength of the front terminal 31 and the rear terminal 32, that is, to increase the stability of the support combination of the inner and outer sides of the hollow cylindrical structure with the insulator 40 and the insulating seat 10 respectively, improve the positional accuracy of the central terminal 20, and ensure reliable contact with the docking connector. At the same time, the radio frequency leakage defect at the joint line of the stamped circular structure is solved, improving the quality of high-frequency data transmission. Compared with the existing technology, this seamless forming method can prevent black screen phenomenon caused by poor connection, especially in automatic driving, which increases safety hazards.

Of course, in other embodiments, only one of the front terminal 31 and the rear terminal 32 is required to adopt a seamless molding process to form a hollow cylindrical structure, which can also achieve the present invention. As the insulator 40 or the insulation seat 10 is injection molded, its inner wall is relatively flat, so the outer side of the insulator 40 and the outer side of the hollow cylindrical structure fit or the inner side of the insulation seat 10 and the outer side of the hollow cylindrical structure fit maintain a stable fit. Furthermore, the seamless structure formed by the front terminal 31 enables the front terminal 31 to provide stable contact with the docking connector; the rear terminal 32 forms a seamless structure, which can improve the docking position of the central terminal 20. In this embodiment, by using hollow cylindrical structures for the front and rear terminals respectively, and fixing them together by welding, the above two technical problems of stable contact and positional accuracy of docking can be solved simultaneously.

The insulator 40 is provided with an inner through hole 41 passing through the insulator 40 from front to back, the central terminal 20 is completely inserted into the inner through hole 41, and the insulator 40 is inserted and fixed inside the external terminal 30 for insulation isolation between the center terminal 20 and the external terminal 30.

The riveting part 50 includes a front riveting portion 51 and a rear riveting portion 52 connected front and back, the front riveting portion 51 is located in the fixing hole 15 of the insulating seat 10, and is riveted on the outer surface of the outer connecting portion 323, the rear riveting portion 52 is riveted on the outer side of the insulating sheath 64 of the cable 60.

The cable 60 includes a conductor 61, an insulating layer 62, a metal braided layer 63, and an insulating sheath 64 arranged from inside to outside. The insulating layer 62 wraps around the conductor 61, and the braided layer 63 is between the insulating layer 62 and the insulating sheath 64. The front end of conductor 61 extends forward beyond insulator 62 and is connected to the central connection portion of central terminal 20. The front end of the insulating layer 62 extends into the rear through-hole 3230 of the rear terminal 32, and the front end of braided layer 63 is clamped and fixed between the outer connecting portion 323 of external terminal 30 and the front riveting portion 51 of the riveting part 50. The braided layer 63 surrounds the outer connecting portion 323, thus achieving electrical connection between the braided layer 63 and the external terminal 30.

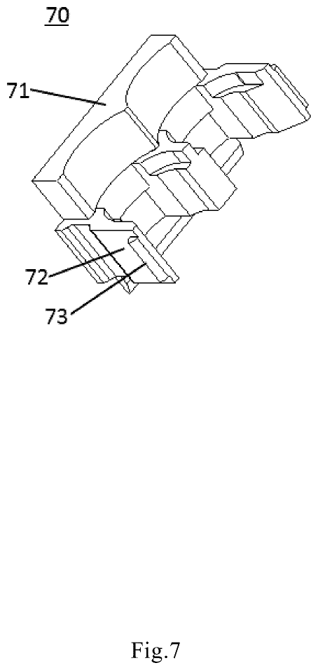

Referring to FIG. 7, each secondary buckle 70 is E-shaped in the front-to-rear direction, and includes a base 71, a plurality of locking arms 72 extending inwardly from the base 71, and a pair of buckle protrusions 73 defined at the ends of the locking arms 72 located on the upper and lower sides. Each base 71 is fixed in the corresponding fixed opening 130 of the insulating seat 10, the locking arms 72 are snapped on the outer connecting portion 323 of the rear terminal 32, and abut against the rear sleeve portion 322 forward to prevent the rear terminal 32 from retreating. The top wall 11 and the bottom wall 12 of the insulating seat 10 are respectively provided with notches 110 and 120 to snap together with the buckle protrusions 73 of the corresponding locking arms 72, so as to prevent the secondary buckles 70 from loosening or falling off on the insulation seat 10.

The external terminal 30 of the cable connector 100 of the present invention adopts a hollow cylindrical structure made by a seamless molding process, which improves the external accuracy and stability of the external terminal 30, and increases the structural strength of the external terminal 30, that is, that is, to increase the stability of the support combination of the inner and outer sides of the hollow cylindrical structure with the insulator 40 and the insulating seat 10 respectively, improve the positional accuracy of the central terminal 20, and ensure reliable contact with the docking connector. At the same time, the radio frequency leakage defect at the joint line of the stamped circular structure is solved, improving the quality of high-frequency data transmission. Compared with the existing technology, this seamless forming method can prevent black screen phenomenon caused by poor connection, especially in automatic driving, which increases safety hazards

However, the disclosure is illustrative only, changes may be made in detail, especially in matter of shape, size, and arrangement of parts within the principles of the disclosure.

What is claimed is:

1. A cable connector, comprising:
an insulative seat;
at least one external terminal fixed inside the insulating seat and including an outer contacting portion located at the front end and an outer connecting portion located at the rear end;
at least one insulator inserted and fixed inside the external terminal;
at least one central terminal inserted and fixed in the insulator for the insulator isolation the central terminal from the external terminal, and the central terminal including a central contacting portion located at the front end and a central connecting portion located at the rear end; and
at least one cable extending backward from the insulating seat, the cable including a conductor, an insulating layer wrapping around the conductor, an insulation sheath, and a metal braided layer between the insulating layer and the insulation sheath, the central connecting portion connected to the conductor, and the outer connecting portion connected to the braided layer;
wherein the external terminal is provided with a seamless hollow cylindrical structure, and the insulator is placed inside the hollow cylindrical structure, and the hollow cylindrical structure is supported on the insulating seat.

2. The cable connector according to claim 1, wherein the external terminal includes a front terminal and a rear terminal which are nested together from front to back, at least one of the front terminal and the rear terminal is made of a seamless molding process.

3. The cable connector according to claim 2, wherein the front terminal and the rear terminal are welded together by laser or resistance.

4. The cable connector according to claim 2, wherein the front terminal includes a front sleeve portion extending backward from the external contacting portion, the rear terminal includes a rear sleeve portion, and the outer connecting portion is extending backward from the rear sleeve portion, the front sleeve portion and the rear sleeve portion are plugged together front and back, and the outer contacting portion is equipped with a slot to provide elastic contact with a docking connector.

5. The cable connector according to claim 4, wherein the rear sleeve portion defines a front through-hole, and the outer connecting portion defines a rear through-hole, the inner diameter of the front through-hole is larger than the inner diameter of the rear through-hole, and the front sleeve portion is inserted into the front through-hole of the rear sleeve portion.

6. The cable connector according to claim 4, wherein the outer diameter of the rear sleeve portion is larger than the outer diameter of the outer connecting portion.

7. The cable connector according to claim 4, wherein the cable connector also includes a riveting part riveted on the outer connecting portion of the external terminal, and the front end of the braided layer of the cable is clamped and fixed between the riveting part and the outer connecting portion.

8. The cable connector according to claim 7, wherein the insulating seat includes at least one insertion hole and at least one fixing hole extending backward from the insertion hole, the central contacting portion and the outer contacting portion are located in the insertion hole, and the riveting part includes a front riveting portion and a rear riveting portion connected front and back, the front riveting portion is riveted to the outer surface of the outer connecting portion, the rear riveting portion is riveted on the outer side of the insulating sheath of the cable, and the fixing hole is equipped with a protrusion located on the inner wall which abuts against the front sleeve portion of the external terminal.

9. The cable connector according to claim 8, wherein the cable connector also includes a pair of secondary buckles fixed on the left and right sides of the insulating seat, the insulating seat includes a top wall, a bottom wall, and a pair of side walls located on the left and right sides, each side wall defines a fixed opening which communicates with the fixing holes, each secondary buckle includes a base fixed to the corresponding fixed opening and a plurality of locking arms extending inwardly from the base, the locking arms are snapped on the outer connecting portion and abut against the rear sleeve portion forwardly.

10. The cable connector according to claim 9, wherein the secondary buckle includes a pair of buckle protrusions defined at the ends of the locking arms located on the upper and lower sides, the top wall and the bottom wall of the insulating seat are respectively provided with notches to snap together with the corresponding buckle protrusions, so as to prevent the secondary locking buckle from loosening or falling off on the insulation seat.

11. A cable connector, comprising:
an insulative seat;
a plurality of terminal components fixed inside the insulating seat, each terminal component defining a central terminal, an external terminal and an insulator located between the central terminal and the external terminal, the central terminal inserted and fixed in the insulator and including a central contacting portion located at the front end and a central connecting portion located at the rear end, the external terminal sleeved on the outside of the insulator, and the insulator insulation isolation the center terminal and the external terminal, the external terminal fixed inside the insulating seat and including an outer contacting portion located at the front end and an outer connecting portion located at the rear end; and
a plurality of cables connected to the corresponding terminal components and extending backward from the insulating seat;
wherein the external terminal includes a front terminal and a rear terminal which nested together from front to back, at least one of the front terminal and the rear terminal is provided with a seamless hollow cylindrical structure, and the insulator is placed inside the hollow cylindrical structure, and the hollow cylindrical structure is supported on the insulating seat.

12. The cable connector according to claim 11, wherein both of the front terminal and the rear terminal are provided with a seamless hollow cylindrical structure, the front terminal and the rear terminal are welded together by laser or resistance.

13. The cable connector according to claim 11, wherein the front terminal includes a front sleeve portion extending backward from the external contacting portion, the rear terminal includes a rear sleeve portion, and the outer connecting portion is extending backward from the rear sleeve portion, the front sleeve portion and the rear sleeve portion are plugged together front and back, and the outer contacting portion is equipped with a slot to provide elastic contact with a docking connector.

14. The cable connector according to claim 13, wherein the rear sleeve portion defines a front through-hole, and the outer connecting portion defines a rear through-hole, the inner diameter of the front through-hole is larger than the inner diameter of the rear through-hole, and the front sleeve portion is inserted into the front through-hole of the rear sleeve portion.

15. The cable connector according to claim 13, wherein the rear sleeve portion of the rear terminal is inserted into the front sleeve portion of the front terminal.

16. The cable connector according to claim 13, wherein each cable includes a conductor, an insulating layer wrapping around the conductor, an insulation sheath, and a metal braided layer between the insulating layer and the insulation sheath, the central connecting portion is connected to the conductor, and the outer connecting portion is connected to the braided layer.

17. The cable connector according to claim 16, wherein the cable connector also includes a riveting part riveted on the outer connecting portion of the external terminal, and the front end of the braided layer of the cable is clamped and fixed between the riveting part and the outer connecting portion.

18. The cable connector according to claim 17, wherein the insulating seat includes at least one insertion hole and at least one fixing hole extending backward from the insertion hole, the central contacting portion and the outer contacting portion are located in the insertion hole, and the riveting part includes a front riveting portion and a rear riveting portion connected front and back, the front riveting portion is riveted to the outer surface of the outer connecting portion, the rear riveting portion is riveted on the outer side of the insulating sheath of the cable, and the fixing hole is equipped with a protrusion located on the inner wall which abuts against the front sleeve portion of the external terminal.
